(19) United States
(12) Patent Application Publication
(10) Pub. No.: US 2016/0121937 A1
(43) Pub. Date: May 5, 2016

(54) FASTENING APPARATUS FOR VEHICLE SHEET COMPONENT

(71) Applicant: Ford Global Technologies, LLC, Dearborn, MI (US)

(72) Inventor: Matthew Forsyth, Detroit, MI (US)

(73) Assignee: Ford Global Technologies, LLC, Dearborn, MI (US)

(21) Appl. No.: 14/528,518

(22) Filed: Oct. 30, 2014

(51) Int. Cl. B62D 27/02

(52) U.S. Cl. CPC B62D 27/02

(57) ABSTRACT

An assembly includes a sheet component, a joint base, and a brazed bond therebetween. The sheet component includes aluminum and an aperture, and the joint base has first and second portions and a fastener coupling. The first portion of the joint base overlaps the aperture and engages a first side of the sheet component, and the second portion of the joint base extends through the aperture and engages a second side of the sheet component. The fastener coupling is larger than the aperture.

### BACKGROUND

Vehicles, such as automobiles, pick-up trucks, sport-utility vehicles, minivans, vans and other passenger vehicles, have traditionally utilized steel for their structure. However, the need for more efficient vehicles has led to consideration of a variety of structural and body materials, depending on particular vehicle design specifications. For example, to help meet fuel efficiency targets or requirements, vehicles may incorporate aluminum in place of and/or in addition to traditional steel components to reduce weight while maintaining suitable strength and stiffness performance. However, traditional manufacturing and assembly strategies may not be suitable for alternative materials such as aluminum. For example, it is currently difficult to provide an attachment point secured to a relatively thin aluminum or aluminum-based sheet component sufficiently robust for mass market passenger vehicle applications.

### DRAWINGS

FIG. 1 is a perspective view of an exemplary joint base according to the principles of the present disclosure spaced apart from a sheet metal component for a vehicle.

FIG. 2 is a perspective view of an assembly of the joint base and sheet metal component of FIG. 1.

FIGS. 3A-3B are cross-sectional views of the assembly of the joint base and sheet metal component of FIG. 2 with a punch member before and after deformation of the joint base to clamp the sheet metal component according to the principles of the present disclosure.

FIG. 3C is a cross-sectional view of assembly of the joint base and the sheet metal components of FIG. 3B, further illustrating a bond formed between the joint base and the sheet metal component.

FIG. 4 is a perspective view of the assembly of the joint base and the sheet metal component of FIG. 3C.

FIG. 5 is perspective view of another assembly of a joint base and a sheet metal component according to the principles of the present disclosure with two bonds formed therebetween.

FIG. 6 is perspective view of an assembly of another joint base and a sheet metal component according to the principles of the present disclosure with three bonds formed therebetween.

FIG. 7 is a cross-sectional view of the assembly of the joint base and the sheet metal component of FIGS. 3C and 4 with a fastener engaging the joint base and coupling another vehicle component relative to the sheet metal component.

### DETAILED DESCRIPTION

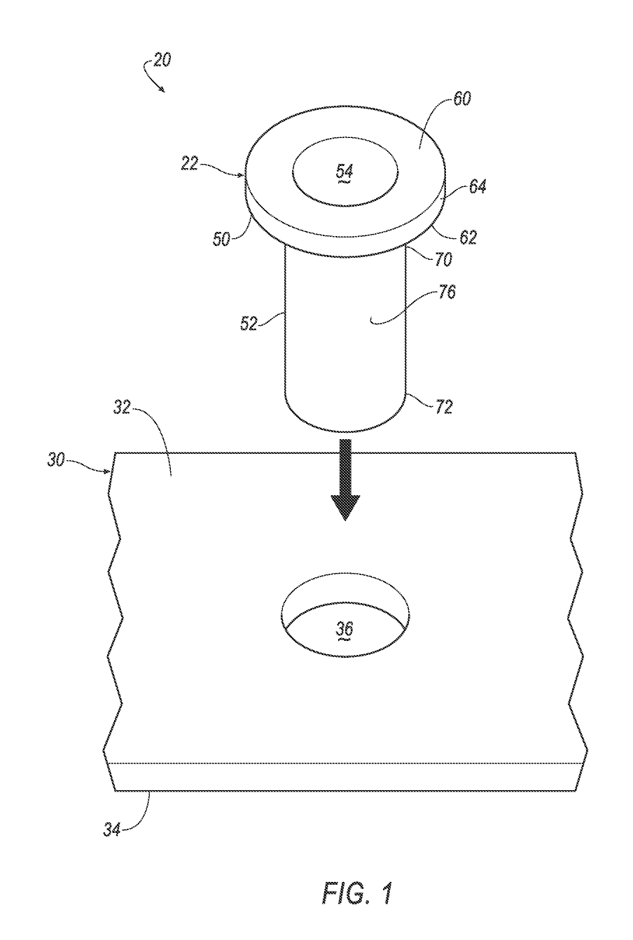

FIG. 1 is a perspective view of components for an exemplary joint assembly 20 for a vehicle according to the principles of the present disclosure. The joint assembly 20 includes a joint base 22 and a sheet component 30. The sheet component 30 includes aluminum; that is, it may be an aluminum or an aluminum-based metallic material. In one example, sheet component 30 is a body component for a vehicle such as a passenger car, sport-utility vehicle, minivan, etc. It should be understood that the principles of the present disclosure may be applicable to a variety of vehicle assemblies and components.

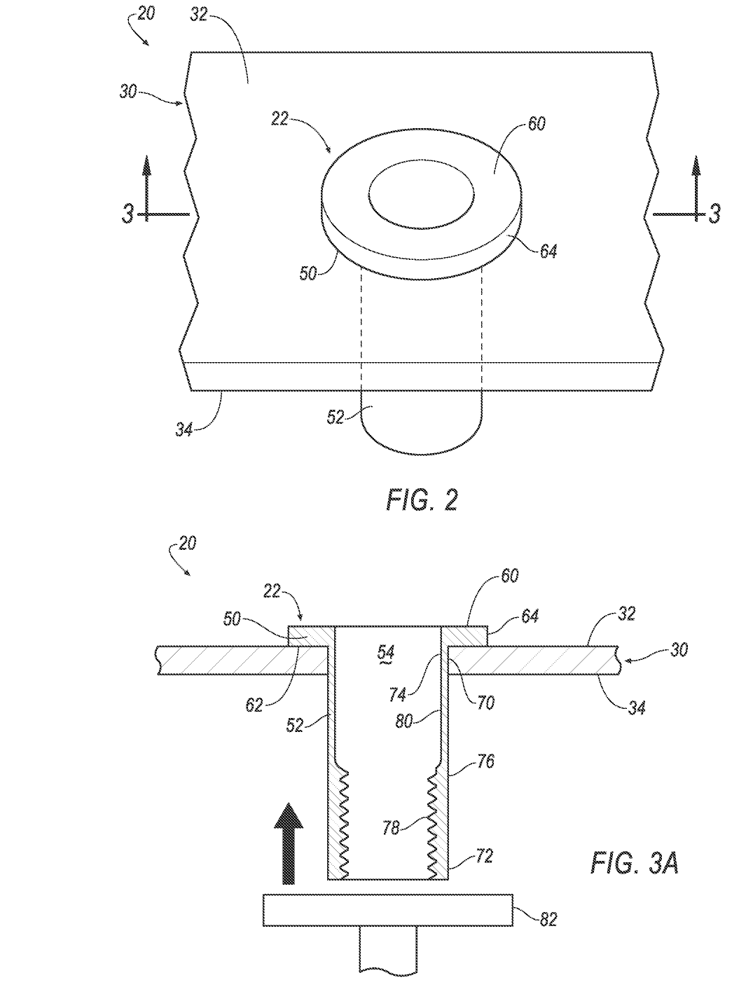

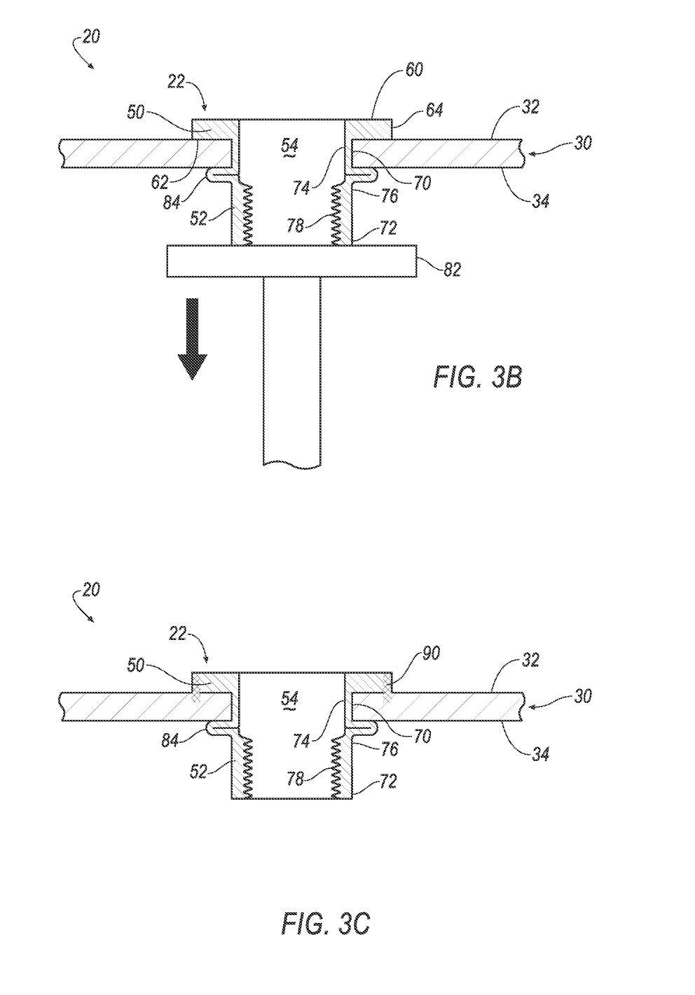

Sheet component 30 has a generally thin configuration between substantially flat first and second sides 32, 34. With further reference to FIGS. 2 and 3A, the sheet component 30 includes a through aperture 36 extending between the first and second sides 32 and 34. In some implementations, sheet component 30 may be as thin as approximately 1 millimeter between the first and second sides 32, 34.

The joint base 22 includes first and second portions 50 and 52. The first portion 50 is relatively wider and shorter than the second portion 52. The second portion 52 is sized complementarily to the through aperture 36 of the sheet component 30. The joint base 22 engages the sheet component 30 with the first portion 50 of the joint base 22 abutting the first side 32 of the sheet component 30 and the second portion 52 of the joint base 22 extending into and through the through aperture 36. The joint base 22 has a through passage 54 extending the entire length thereof, through both the first and second portions 50, 52.

The first portion 50 of the joint base 22 may have any suitable shape larger than the through aperture 36. In one implementation, as illustrated in, e.g., FIGS. 1-2, the first portion 50 has a generally annular configuration about the through passage 54 of the joint base 22, with annular top and bottom surfaces 60, 62 and a radially outside surface 64 extending between the top and bottom surfaces 60, 62 at the perimeter of the first portion 50.

The second portion 52 may have any suitable shape that is hollow about the through passage 54 and complementary to the through aperture 36 of the sheet component 30. In one implementation, as illustrated in, e.g., FIGS. 1-2, the second portion 52 has a generally hollow cylindrical configuration about the through passage 54 of the joint base 22. The second portion 52 has a first end 70 at the first portion 50, and a second end 72 at a distal end of the joint base 22. The second portion 52 has interior and exterior surfaces 74 and 76. According to the principles of the present disclosure, the joint base 22 may further include a fastener coupling. In one implementation, as illustrated, e.g., in FIG. 3A, the interior surface 74 of the second portion 52 includes a fastener coupling in the form of a threaded region 78, as well as a non-threaded region 80. It should be understood that a fastener coupling of a joint base according to the principles of the present disclosure may vary according to the configuration of the joint base and the particular application thereof.

The fastener coupling of the joint base 22 provides an interface for a fastener that is larger than the relatively thin depth of the sheet component 30. In one implementation, the threaded region 78 of the joint base 22 may be configured to receive a fastener with a standard threading configuration, such as threads with a space, or pitch, of between 0.75-1.25 millimeters apart from each other. Such a configuration simply could not be accommodated by the sheet component 30 alone, e.g., in implementations where the sheet component 30 may be as thin as approximately 1 millimeter between the first and second sides 32, 34. In other implementations, even if, e.g., an entire or a few revolutions of thread could be possible in a through hole in the sheet component itself, such an interface may not be sufficiently robust, e.g. may not be capable of desired torque levels, for passenger vehicle applications.

With further reference to FIG. 3B, the joint base 22 is deformed into a clamped engagement with the sheet component 30 by a punch member 82. In particular, the second portion 52 of the joint base 22 is deformed at a section 84, corresponding with the non-threaded region 80 of the interior surface 74 of the second portion 52. The section 84 directly abuts the second side 34 of the sheet component 30, and the joint base 22 clamps the sheet component 30 between the bottom surface 62 of the first portion 50 and the section 84 of the second portion 52. Upon deformation of the second portion 52 of the joint base 22, the through passage 54 is maintained through the joint base 22.

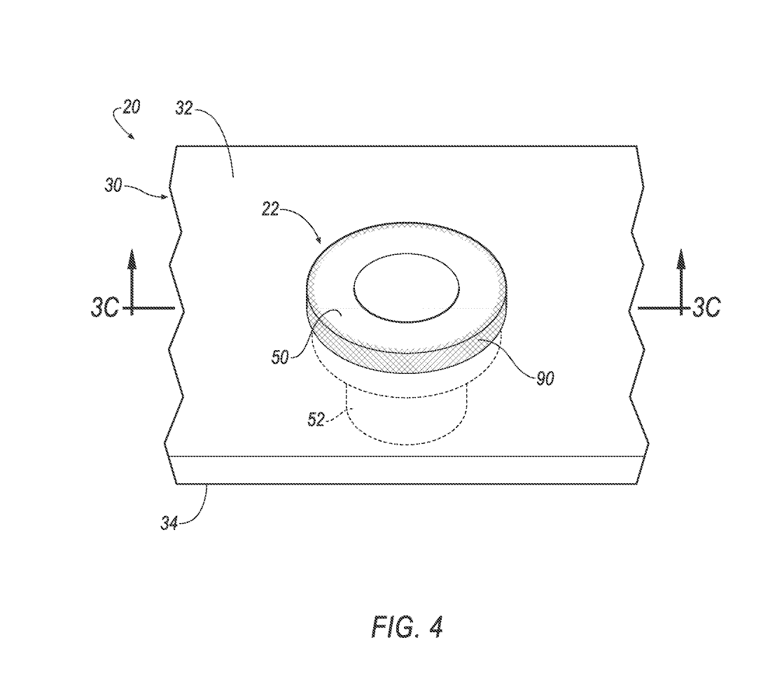

With further reference to FIGS. 3C and 4, the joint assembly 20 further includes a bond 90 between the joint base 22 and the sheet component 30 formed by brazing. The brazed bond 90 secures the joint base 22 relative to the sheet component 30 in addition to the clamping force of the joint base 22 on the sheet component 30, to inhibit rotation of the joint base relative to the component 30—e.g., when a fastener is threaded into the joint base 22 and/or torqued relative to the joint base 22.

The joint assembly 20 may, in another implementation, include first and second brazed bond segments 90a′ and 90b′ spaced apart and separated from each other about the outside surface 64 of the first portion 50 of the joint base 22, as illustrated in FIG. 4. It is to be understood that a variety of brazed bond configurations may be utilized according to the principles of the present disclosure, according to particular application and design requirements.

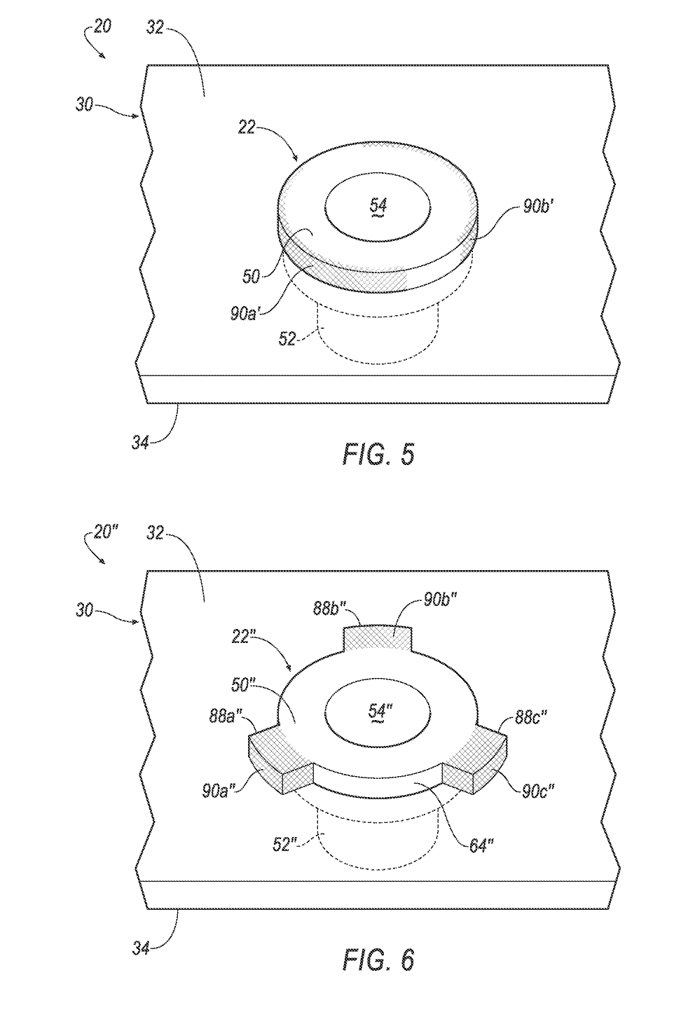

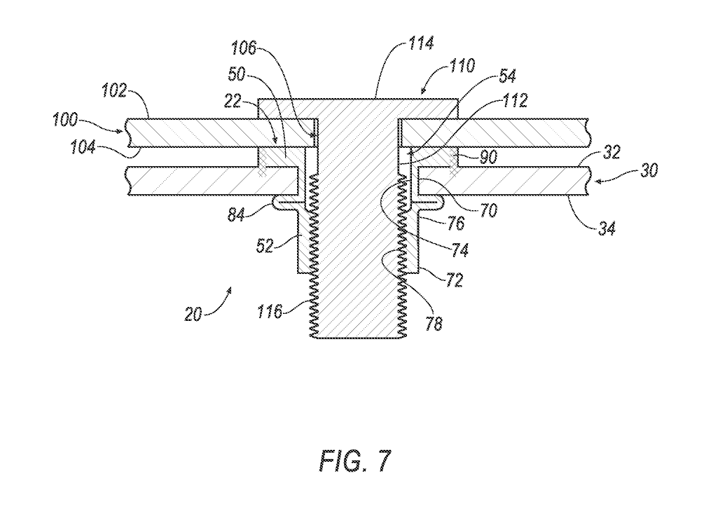

With reference to FIG. 5, another joint assembly 20″ may include a joint base 22″. The first portion 50″ of the joint base 22″ includes tabs 88a″, 88b″ and 88c″ spaced apart about the outside surface 64″ and radially extending from the outside surface 64″. The joint assembly 20″ includes first, second, and third separated brazed bond segments 90a″, 90b″ and 90c″ formed between the tabs 88a″, 88b″ and 88c″ and the sheet component 30, respectively. The radial displacement of the brazed bond segments 90a″, 90b″ and 90c″ from the outside surface 64″ may provide a relatively greater torque resistance to the joint assembly 20″ than such a bond located at the outside surface 64″. It should be understood that, apart from the tabs of the joint base 22″ and respective the brazed bond segments, the description herein of joint assembly 20 equally applies to joint assembly 20″.

With reference to FIG. 7, a second vehicle component 100 may be secured to the sheet component 30 at the joint assembly 20. The second vehicle component 100 has a top surface 102, a bottom surface 104, and a through aperture 106 extending between the top surface 102 and the bottom surface 104. The through aperture 106 is aligned with the through passage 54 of the joint base 22. A fastener 110 extends a shaft 112 through the second vehicle component 100 and engages the fastener coupling of the joint base 22. The fastener 110 further includes a flange 114 that is larger than the through aperture 106 and engages the top surface 102 of the second vehicle component 100. In one implementation, as illustrated in FIG. 7, the fastener 100 includes threads 116 complementary to the threads 78 of the joint base 22. As illustrated in FIG. 7, according to the principles of the present disclosure, the interface between the threads 116 of the fastener and the threads 78 of the joint base 22 may be larger than the through aperture 36 of the sheet component 30. With the joint base 22 secured to the sheet component 30 by brazed bond 90, the joint assembly 20 may accommodate sufficient torque applied to the fastener 110 to secure the second vehicle component 100 relative to the sheet component 30.

In the drawings, the same reference numbers indicate the same elements. Further, some or all of these elements could be changed. Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It should be understood that, as used herein, exemplary refers to serving as an illustration or specimen, illustrative, or typical. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. An assembly comprising:
a sheet component including aluminum and an aperture;
a joint base having first and second portions and a fastener coupling, the first portion overlapping the aperture and engaging a first side of the sheet component, the second portion extending through the aperture and engaging a second side of the sheet component, the fastener coupling being larger than the aperture; and
a brazed bond between the sheet component and the joint base.

2. The assembly of claim 1, wherein the joint base includes a through passage extending through the first and second portions and the aperture of the sheet component.

3. The assembly of claim 2, wherein the fastener coupling is disposed on an interior surface of the through passage.

4. The assembly of claim 3, wherein the fastener coupling includes threads formed on the interior surface of the through passage.

5. The assembly of claim 4, wherein the threads have a pitch that is at least as large as a thickness of the sheet component between the first and second sides.

6. The assembly of claim 1, wherein the brazed bond is between the first side of the sheet component and the first portion of the joint base.

7. The assembly of claim 6, wherein the brazed bond includes at least two separated segments.

8. The assembly of claim 6, wherein the first portion of the joint base includes a plurality of tabs extending from a radially outside surface thereof.

9. The assembly of claim 8, wherein the brazed bond includes a plurality of separated segments between the plurality of tabs of the first portion and the first side of the sheet component.

10. The assembly of claim 1, wherein the second portion of the joint base includes a deformed section engaging the second side of the sheet component.

11. A joint of vehicle components comprising:
first and second components directly overlapping each other, at least the first component including an aluminum material, the first and second components respectively including first and second apertures substantially aligned with each other;
a joint base having first and second portions, the first portion overlapping the first aperture and engaging a first side of the first component, the second portion extending through the first aperture and engaging a second side of the first component, the joint base further including a fastener coupling being larger than the first aperture;
a brazed bond between the first component and the joint base; and
a fastener overlapping and extending through the second aperture of the second component, the fastener extending into the through passage of the joint base and engaging the fastener coupling, the fastener securing the second component relative to the first component.

12. The joint of claim 11, wherein the joint base includes a through passage extending through the first and second portions and the first aperture of the first component.

13. The joint of claim 12, wherein the fastener coupling is disposed on an interior surface of the through passage.

14. The joint of claim 13, wherein the fastener coupling includes threads formed on the interior surface of the through passage.

15. The joint of claim 14, wherein the threads have a pitch that is at least as large as a thickness of the first component between the first and second sides.

16. The joint of claim 11, wherein the brazed bond is between the first side of the first component and the first portion of the joint base.

17. The joint of claim 16, wherein the brazed bond includes at least two separated segments.

18. The joint of claim 16, wherein the first portion of the joint base includes a plurality of tabs extending from a radially outside surface thereof.

19. The joint of claim 18, wherein the brazed bond includes a plurality of separated segments between the plurality of tabs of the first portion of the joint base and the first side of the first component.

20. The joint of claim 11, wherein the second portion of the joint base includes a deformed section engaging the second side of the first component.
